(19) United States
(12) Patent Application Publication
(10) Pub. No.: US 2010/0312754 A1
(43) Pub. Date: Dec. 9, 2010

(54) METHOD AND SYSTEM FOR BACKUP AND RECOVERY

(75) Inventors: Eric Justin Gould Bear, Austin, TX (US); David Bouteruche, Austin, TX (US); Stephane Debroutelle, Lambersart (FR); Christian Leman, Austin, TX (US); Mark Benjamin Power-Freeman, Austin, TX (US); Jan Moorman, Austin, TX (US); Vasken N. Sayre, Austin, TX (US); Peter Oshima, Austin, TX (US)

Correspondence Address: JACKSON WALKER L.L.P.;ATTN: INTELLECTUAL PROPERTY DEPARTMENT, 100 CONGRESS AVENUE, SUITE 1100, AUSTIN, TX, 78701, US

(73) Assignee: SOFTTHINKS SAS, Villeneuve d'Ascq (FR)

(21) Appl. No.: 12/613,689

(22) Filed: Nov. 6, 2009

Related U.S. Application Data
(60) Provisional application No. 61/184,267, filed on Jun. 4, 2009.

(51) Int. Cl. G06F 17/00

(52) U.S. Cl. 707/685; 707/E17.007

(57) ABSTRACT

A method and system for backup and recovery of data objects accessible to a computer system may identify data events associated with the data objects. Metadata providing a record of data events associated with a data object, including information identifying prior versions of a data object may be stored in a central index. An indication of a plurality of data objects may be displayed on a single panel display object, along with a revision history for each displayed data object. The revision history may include an indication of previous versions of the data object, which may be selectable and accessible from the single panel display object. The single panel display object may further display a timeline with a selectable timescale. The timescale may be associated with a color scale, which may also be used in the display of the data objects and their respective revision histories.

### BACKGROUND

1. Field of the Disclosure

The present disclosure relates to the backup and recovery of computer systems and, more particularly, utilizing a centralized index for backup and recovery operations.

2. Description of the Related Art

Backup systems can provide a level of security in the form of recoverability of stored data objects on a storage device of a computer system. During usage of the computer system, the state of the storage device may change continuously. Data objects stored on the storage device may be added, deleted, or modified. A backup operation may be performed, resulting in a backup copy of data objects that can be used to recover original data objects. Various complex operations may be involved when users access previously stored backup versions of data objects.

### BRIEF DESCRIPTION OF THE DRAWINGS

FIG. 1 is a block diagram of selected elements of an embodiment of a backup system;

FIG. 2 is a flow diagram of selected elements of an embodiment of a backup method;

FIG. 3 is a flow diagram of selected elements of an embodiment of a backup method;

FIG. 4 is a diagram of selected elements of an embodiment of a computing device; and

FIGS. 5-14 are selected elements of embodiments of a user interface.

### DESCRIPTION OF THE EMBODIMENT(S)

Backup systems are used to generate backup copies of original data associated with computer systems. As used herein, a “data object” refers to an individual portion of data, or a data structure, that may be stored on a storage device. A data object may refer to an addressable storage location on the storage device, such as a particular sector. A data object may refer to a file system object created by a file system installed on the storage device (i.e., a file or a directory). A data object may also collectively refer to a plurality of data portions, or other data objects. As referred to herein, a “data event” refers to an action performed on a data object, such as creating, accessing, opening, closing, deleting, moving, modifying, revising, or a combination thereof. In theory, a new version of a data object may be defined each time a data event associated with that data object occurs. Embodiments of the disclosed subject matter may store “metadata” about data objects and data events in a central index to provide advanced capability for viewing and recreating data object histories. In these embodiments, the metadata stored in the central index may include information identifying a data object, a data event pertaining to the identified data object, and timestamp information indicating when the data event occurred. In this manner, the metadata associated with a data object may provide a complete history of the data object from its inception to the present time and may further provide information indicating where all previous versions of the data object may be located within the system. By maintaining and centralizing all of the metadata for data objects in a central index, embodiments of the disclosed subject matter facilitate the ability to view and recreate complex data object histories including, for example, the ability to recreate state of a number of data objects at a given point in time and the ability to recreate the state of two or more data objects at different points in time.

As recited herein, a “file system” refers to executable code for organizing a storage partition, such that access to the storage partition is provided using hierarchical information specifying files and directories. The hierarchical information does not specify a physical location on the storage partition on which the file system is created. The file system provides the hierarchical interpretation externally, while managing the physical location addressing of the storage partition internally. In this manner, the data in a given data file may physically occupy various locations, either segmented or contiguous, while appearing outwardly as a single contiguous entity.

In theory, generating a backup copy reduces the risk of lost original data, because the backup copy can then be used to restore the original data. However, practical limits on the actual risk reduction attained with backup systems may arise from various factors. Furthermore, certain types of risk, or consequences, of data loss may not be evenly distributed across the original data. That is, certain portions of the original data may cause much greater damage if lost. The damage from data loss may be secondary, for example, resulting from the unavailability of capital investments, or from lost productivity of human resources, either of which may directly depend on the lost data. Also, some data objects in the original data may experience a much higher rate of access than other data objects. Certain user-defined data objects may be designated as being significantly more valuable than other data objects, and may thus be disproportionately represented in the overall system backup. Additionally, there may be certain risks associated with the location or type of backup medium on which the backup copy is stored. For example, if the only available backup copy is located on the same storage device as the original data, then a failure of that storage device may cause both the original and backup data to be lost.

As a result of the foregoing, a number of previous copies, or versions, of each data object may be stored in the backup data. As will be described in detail below, a central, or centralized, index may store data events for data objects. Upon identification, or detection, of a data event, an indication of the data event and metadata associated with the data object may be stored in the central index. The data objects may include user files, such as documents or digital media that are created and managed by users. The data objects may also include system files, such as operating system components, configuration data, and device drivers for accessing hardware components. Data objects may also be executable program files or executable code.

Based on the central index, a plurality of data objects may be represented in a single panel display object. The display object may simultaneously display data object revision histories for each of the plurality of data objects. The data object revision history may be based on a time scale represented by a color scale of the represented data objects. The timescale may further be represented by a corresponding timeline. In particular embodiments, the timescale may be represented by a color scale exhibited in the single panel display object. In this manner, a user interface may provide an overview of the revision histories for a plurality of data objects in a single panel display object.

In addition to displaying the revision histories for the plurality of data objects, the user may be enabled to access previous versions of data objects from the single panel display object. The previous version of the data objects may be selected in a similar manner to current versions of data objects. Access to data objects may also occur relative to a bookmark, which may be a timestamp marker defined by a user. In certain embodiments, the versions of data objects at the time of the bookmark may be retrieved and accessed by selecting the bookmark.

In one aspect, a disclosed method for a central index of a computing environment may include identifying data events respectively associated with data objects stored in the computing environment, and storing an indication of an identified data event, including a timestamp, in the central index. The data objects may include user files and system files. When the identified data event represents revision of a respective data object, the method may include storing metadata associated with the revised data object in the central index. When the identified data event represents creation of a respective data object, the method may further include storing metadata associated with the created data object in the central index. When the identified data event represents deletion of a respective data object, the method may include storing metadata associated with the deleted data object in the central index. The data objects may further include at least one executable program file, while the data events may include: installation, setup, modification, renaming, moving, error reporting, deletion, and permanent deletion.

In particular embodiments, the system files may include at least one hardware driver file for accessing a hardware component of the computing environment. A data event associated with a hardware driver file may indicate at least one of: configuration of the hardware component, an error of the hardware component, failure of the hardware component, removal of the hardware component from the computing environment, and detection of the hardware component being added to the computing environment. The method may further include displaying a selectable representation of a plurality of the data objects in a single panel display object, while the representation may include data object revision histories retrieved from the central index. The represented data objects may include coloring according to a color scale, while the color scale may represent a time scale of a data object revision history. The color scale may be a botanic color scale.

In given embodiments, the method may still further include representing the time scale and the color scale with a timeline for the plurality of data objects, and enabling a user to provide user input to the timeline for selecting the time scale. The representation of the data object revision history may include a respective timeline for data objects within the single panel display object. The timeline may represent a non-linear timescale for time units ranging from hours to at least one of: days, weeks, and months. The timeline may include a means for selecting between a time range with dual time selectors and a time snapshot with a single time selector. When the time range is selected, the dual time selectors may increment by a given time unit. When the time snapshot is selected, the single time selector may increment by previous backup events that have been performed on the computing environment. The data object revision histories may be represented as stacks associated with the represented data objects, while the size of the stacks may correlate with a number of data events occurring within a selected time range. The topmost item in the stack may indicate the number of data events represented in the stack. The items in the stack may be colored according to a color scale that represents a time scale. The topmost item in the stack of a deleted data object may include a deletion graphic element.

In certain embodiments, the method also includes enabling a user to access a previous version of a data object from a data object revision history, including at least one of: selecting, retrieving, displaying, comparing, sending, opening, executing, forwarding, copying, and emailing. The method may further include querying the central index for data objects that satisfy a criteria associated with a data object attribute, while the data object attribute may specify at least one of: size, type, location, creation date, modification date, deletion date, owner, and security information. The method may further include deleting the data objects returned by said querying.

In some embodiments, the method may further include storing a bookmark in the central index, wherein the bookmark includes a user-specified timestamp associated with the computing environment. The method may further include querying the central index for versions of data objects associated with a bookmark, and displaying the data objects returned by said querying. The versions of data objects associated with a bookmark may be previously stored copies of the data objects at the time of the bookmark timestamp. Responsive to user input, the method may further include enabling the user to delete previous versions of data objects stored in the central index.

In a further aspect, a disclosed computer system may include a processor, a storage device configured for storing data objects, a display device for displaying a user interface, and memory media accessible to the processor, including processor executable instructions. The memory media may include processor executable instructions to identify data events respectively associated with data objects stored on the storage device, wherein the data objects include user files and system files, and store an indication of an identified data event, including a timestamp, in the central index. The computer system may also include processor executable instructions to represent a plurality of data objects in a single panel display object of the user interface, including processor executable instructions to represent revision histories for the respective represented data objects, while the revision history may represent a plurality of data objects in a single panel display object of the user interface, including processor executable instructions to represent revision histories for the respective represented data objects, wherein the revision history is retrieved from the central index.

In certain embodiments, the computer system may further include processor executable instructions to store metadata associated with the created data object in the central index when the identified data event represents creation of a respective data object. The computer system may further include processor executable instructions to store metadata associated with a revised data object in the central index when the identified data event represents revision of a respective data object. The computer system may still further include processor executable instructions to store metadata associated with a deleted data object in the central index when the identified data event represents deletion of a respective data object. The revision histories may include information indicative of previous versions for the respective data object.

In particular embodiments, the computer system may further include processor executable instructions to retrieve a previous version of a data object from the central index, responsive to user input, and display the previous version of the data object on the display device. The represented data objects may include coloring according to a color scale, while the color scale may represent a time scale of a data object revision history. The displayed color scale may be a botanic color scale. The data events may include: installation, setup, modification, error reporting, and deletion.

In yet another aspect, a disclosed computer-readable memory media may include executable instructions for maintaining a central index of a computing environment. The instructions may be executable to identify data events respectively associated with data objects stored in the computing environment, wherein the data objects include user files and system files, and store an indication of an identified data event, including a timestamp and a location of an associated data object, in the central index. The instructions may also be executable to store metadata associated with a created data object in the central index when the identified data event indicates creation of a respective data object, store metadata associated with a revised data object in the central index when the identified data event indicates revision of a respective data object, and store metadata associated with a deleted data object in the central index when the identified data event indicates deletion of a respective data object.

In particular embodiments, the memory media may further include instructions executable to display indications of a plurality of data objects in a single panel display object, including executable instructions to display an indication of revision histories for respective data objects, while the revision histories may be retrieved from the central index. The data objects may be stored on a plurality of storage devices accessible to the computing environment. The storage devices may include at least one of: optical storage devices, internal storage devices, external storage devices, storage-area networks, networked storage devices, bus-interfaced storage devices, and solid-state storage devices. A location of at least one data object may be given by a universal resource locator (URL).

In given embodiments, the memory media may further include instructions executable to delete copies of a data object stored in the central index. The deleted copies may be selected based on age.

In the following description, details are set forth by way of example to facilitate discussion of the disclosed subject matter. It should be apparent to a person of ordinary skill in the field, however, that the disclosed embodiments are exemplary and not exhaustive of all possible embodiments.

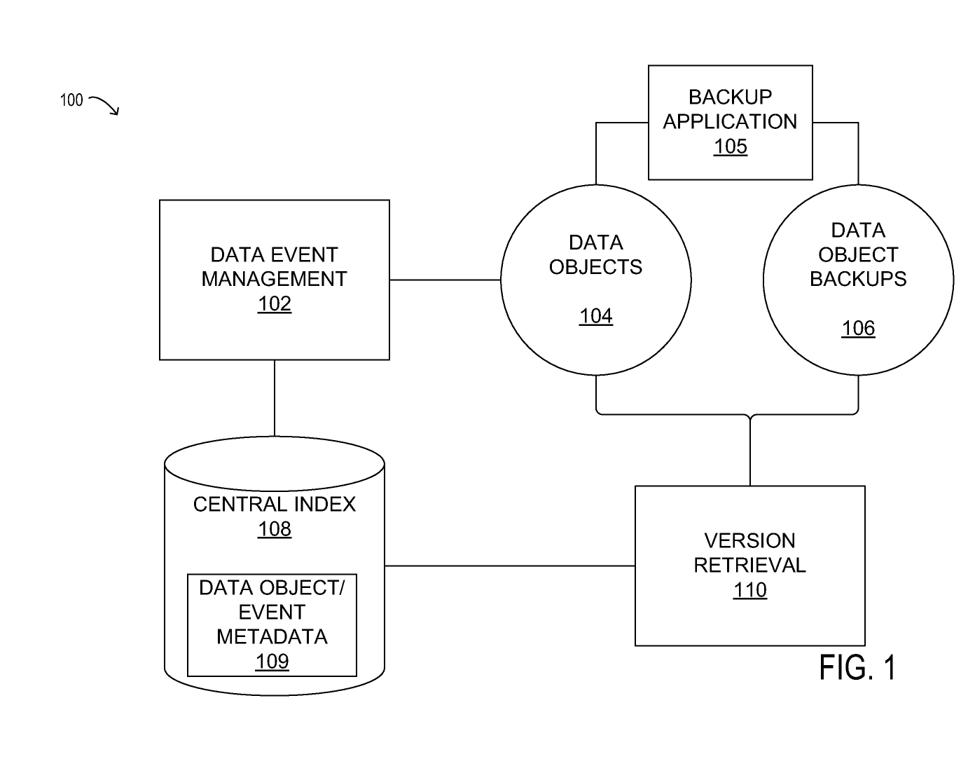

Referring now to FIG. 1, a block diagram of selected elements of an embodiment of backup system 100 are presented. Backup system 100 is depicted in generalized form for clarity and elements of backup system 100 are shown in terms of functionality. It will be understood that backup system 100 may be embodied on a single computer system, or may be distributed across different computer systems and networks, as desired in various embodiments. As shown in FIG. 1, backup system 100 includes data event management 102, data objects 104, backup application 105, backup objects 106, central index 108 including data object/event metadata 109, and version retrieval 110. It is noted that although data event management 102 and version retrieval 110 are depicted in FIG. 1 as separate modules, these two elements may be combined into a single functional entity in certain embodiments. Backup application 105 represents resources responsible for managing and generating one or more copies of some or all of data objects 104. These backup copies of data objects 104 are referred to herein as data objects backups 106. Exemplary implementations of backup application 105 are disclosed in co-pending U.S. patent application entitled Method and System for Maintaining Data Recoverability, Ser. No. 12/553,579, filed Sep. 3, 2009, which is commonly owned with this application.

Backup system 100 includes data event management 102, which may include executable code for performing the operations described herein. Data event management 102 may detect data events associated with data objects 104. Data event management 102 may interface with other software components associated with a particular computer system, such as user interface modules, device interfaces, network interfaces, etc. Data event management 102 may be configured to detect when a data event for a particular data object in data objects 104 occurs, and may then identify both the data event and the data object. Data event management 102 may then store the indication of the data event and/or the data object as metadata 109 associated with the data object, in central index 108.

Data objects 104 may represent a collection of data objects, as described above, associated with a computer system. Backup system 100 may be configured to operate with various collections of data objects in a given computing environment, as desired. When data objects 104 include data files, the data files may be referenced via a file system configured on a storage device (not shown in FIG. 1). Data objects 104 represent the currently used versions of data objects on a computer system.

In some embodiments, metadata 109 in central index 108 includes a repository of information about data objects and data events. The metadata 109 may include records of indexed entries associated with data events and data objects. The metadata 109 for a particular data object may include all of the information necessary to create a complete history of the data object from its creation to the present time including information indicating where each previous version of a data object is stored. In certain embodiments, central index 108 and/or metadata 109 may be a database accessible to data event management 102 and version retrieval 110. Central index 108 may be stored locally on the same computer system as data objects 104. In some embodiments, at least a portion of central index 108 may be stored remotely on a server computer and may be accessible via a network connection. In certain embodiments, data event management 102 may access central index 108 for processing records, including creation, modification, and deletion. It is noted that data events and copies of a given data object, collected over time and stored in central index 108, may represent a “revision history” for that data object.

Version retrieval 110 may be configured to access metadata 109 in central index 108 to create revision histories for selected data objects and/or retrieve versions of data objects from data objects 104 and/or data object backups 106. Version retrieval 110 may provide revision histories for data objects and other information to a user-interface component of a computer system (not shown in FIG. 1). In particular embodiments, version retrieval 110 may itself include a user-interface component for generating single panel display objects, as will be described in detail below. Version retrieval 110 may accordingly accept user input describing a timeline and a storage location, and in response, execute a query on central index 108 for data objects and their revision histories matching the user input. In certain embodiments, version retrieval 110 may directly receive user input, or receive user input via a user-interface component. Version retrieval 110 may then use the queried information to generate, or cause to be generated, various types of single panel display objects that display data objects and their respective revision histories in a single panel. Version retrieval 110 may be configured to interactively respond to user input involved with navigating a single panel display object. For example, user input selecting a previous version of a given data object from a displayed revision history may be received by version retrieval 110 and used to obtain the selected version from central index 108. Version retrieval 110 may be configured to query information from central index 108 based on a single point in time, such as a bookmark or a snapshot, or based on a range, or period, of time. A display of data objects, as will be described in detail below, may be based on the results of a query by version retrieval 110.

Thus, in operation, backup system 100 may continuously monitor and detect data events associated with data objects 104 and store data events and versions of data objects in central index 108. Then, central index 108 may be queried for previous versions and revision histories for desired data objects, which information can be used to provide single panel display objects for viewing and accessing revision histories for a plurality of data objects. A user interface, based on backup system 100, may provide the ability to access previous versions and revision histories of data objects and may include a time scale in the form of a color scale, as will be described in detail below.

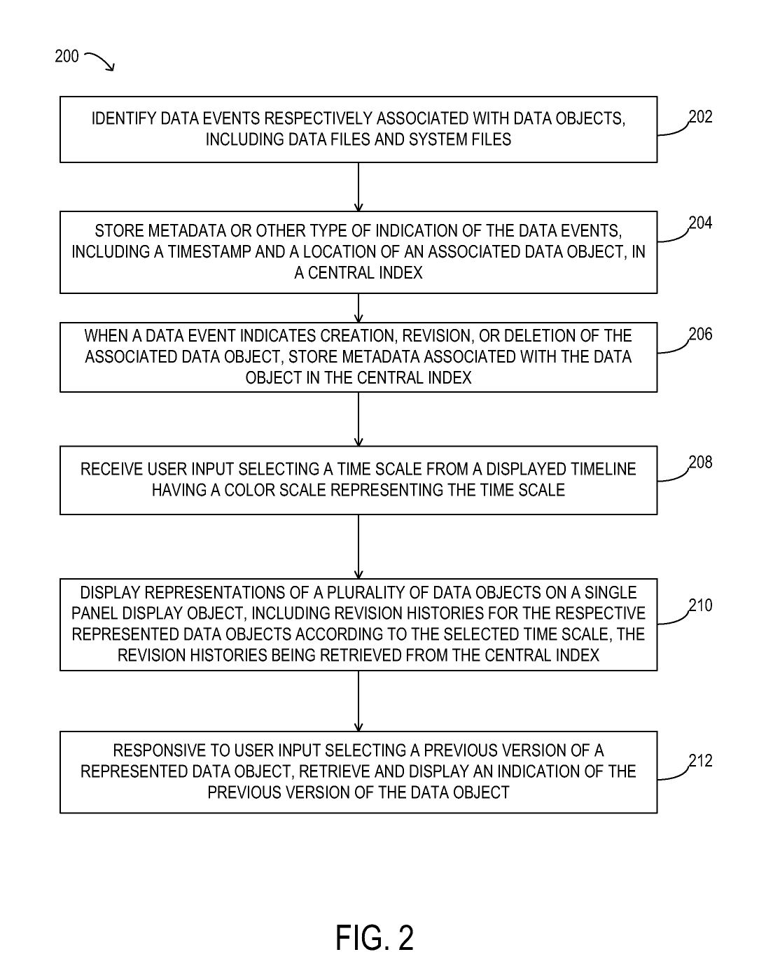

Referring now to FIG. 2, a block diagram of selected elements of an embodiment of backup method 200 is presented. It is noted that at least a portion of backup method 200 may be executed by backup system 100 (see FIG. 1). In various embodiments, operations in backup method 200 may be omitted or rearranged, as desired.

Data events respectively associated with data objects, including data files and system files, may be identified (operation 202). Data files may include user-created files, documents, images, videos, software applications, databases and other data structures, etc. System files may include operating system files, device drivers, and hardware-related files. In particular, device drivers may include a hardware driver file for accessing a hardware component of the computing environment. The hardware component may be a removable peripheral device coupled to the computing environment. The hardware driver file may be used to provide a service for accessing the corresponding hardware component compliant with an input/output architecture of an operating system executing on the computing environment, such as a hardware-abstraction layer. Data events associated with hardware driver files may indicate at least one of the following: configuration of the hardware component, an error of the hardware component, failure of the hardware component, removal of the hardware component from the computing environment, and detection of the hardware component being added to the computing environment. Such data events may also be associated with the input/output architecture and/or the hardware-abstraction layer.

In certain embodiments, the data events may be continuously identified in real-time while a user is operating a computer system storing the data objects. An indication of the data events, including a timestamp and a location of an associated data object, may be stored in a central index (operation 204) as metadata or otherwise. The timestamp may describe the time that the data event occurred. The location of a data object may be a file system identifier, such as a file path. When a data event indicates creation, revision, or deletion of the associated data object, metadata associated with the data object may be stored in the central index (operation 206). In certain embodiments, the central index may include a separate repository for binary large objects (BLOBs) in which data objects are stored and indexed. A revision of a data object may represent any change to the data object. A deletion of a data object may include designating the data object for deletion, without removal of the data object from storage. It is noted that the central index may grow over a time period of usage of a computer system on which backup method 100 is used.

Continuing with backup method 200, user input selecting a time scale from a displayed timeline having a color scale representing the time scale may be received (operation 208). The color scale may itself be user defined. In various embodiments, the color scale may be a “botanic scale,” which may exhibit hues from bright green to dark brown, representing the seasonal change in color of certain plant matter, such as leaves from deciduous trees. The botanic scale may further represent time scales similar to the color change experienced by plants. For example, green hues may represent the duration of a single season in the past, or approximately the latest 3-4 months. Light brown tones may further represent a subsequent season, or a further 3-4 months in the past. The overall scale of the botanic scale may be approximately 1 year in duration. Other type of color scales and other types of botanic scales may also be implemented in various embodiments.

Representations of a plurality of data objects, including revision histories for the respective represented data objects according to the selected time scale, may be displayed, the revision histories being retrieved from the central index (operation 210). The display of the revision histories for the plurality of data objects may include selectable prior versions of the data objects. The time scale may be represented by a botanic scale, as described above. Responsive to user input selecting a previous version of a represented data object, an indication of the previous version of the data object may be retrieved and displayed (operation 212). In certain instances, metadata associated with the previous version may be retrieved from the central index and displayed as another data object.

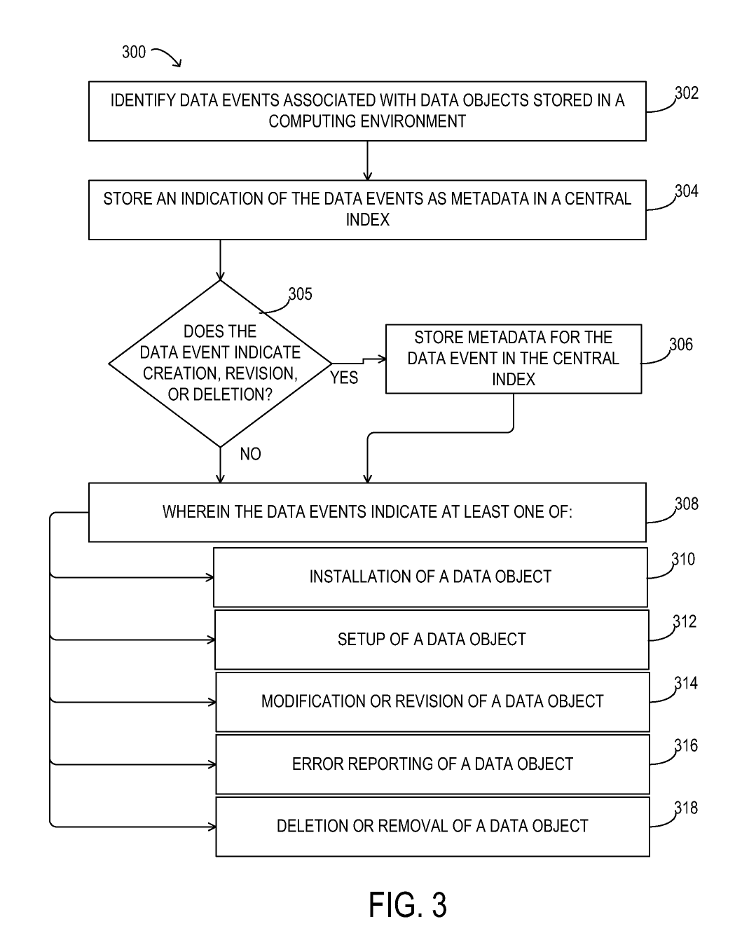

Referring now to FIG. 3, a block diagram of selected elements of an embodiment of backup method 300 is presented. It is noted that at least a portion of backup method 300 may be executed by backup system 100 (see FIG. 1). In various embodiments, operations in backup method 300 may be omitted or rearranged, as desired.

Data events associated with data objects stored in a computing environment may be identified (operation 302). The data objects may be files in the computing environment, while the data events describe file system actions associated with the files, as described above with respect to operation 202 (see FIG. 2). In certain embodiments, the data events may be continuously identified in real-time while a user is operating a computer system storing the data objects. Metadata or other type of indication of the data events may be stored in a central index (operation 304). Next, a decision is made, whether the data event indicates creation, revision, or deletion of the data object (operation 305). If the result of operation 305 is YES, then metadata associated with the data object and/or data event may be stored in the central index (operation 306), either immediately or at the next scheduled time for a backup operation. If the result of operation 305 is NO, or subsequent to operation 306, the data event may indicate at least one of a variety of properties of a data object (operation 308). The data event may indicate the installation of a data object (operation 310). Installation of a data object may include installation and registration of related components and data objects on the computing environment. The data event may indicate setup of a data object (operation 312). Setup of a data object may include configuration, establishing parameters, settings, default settings and other tasks associated with a data object. Setup of a data object may include storing information related to the setup. A data event may indicate modification or revision of a data object (operation 314). A modification or revision may include renaming or moving a data object to a new location. A data event may indicate error reporting of a data object (operation 316). A data event may include deletion or removal of a data object (operation 318). Deletion of a data object may be a permanent or a reversible operation. A permanent deletion may refer to an inability to physically or logically restore the data object, which may encompass a physical operation on a storage device. Removal of a data object may include designating the data object for deletion at a future time.

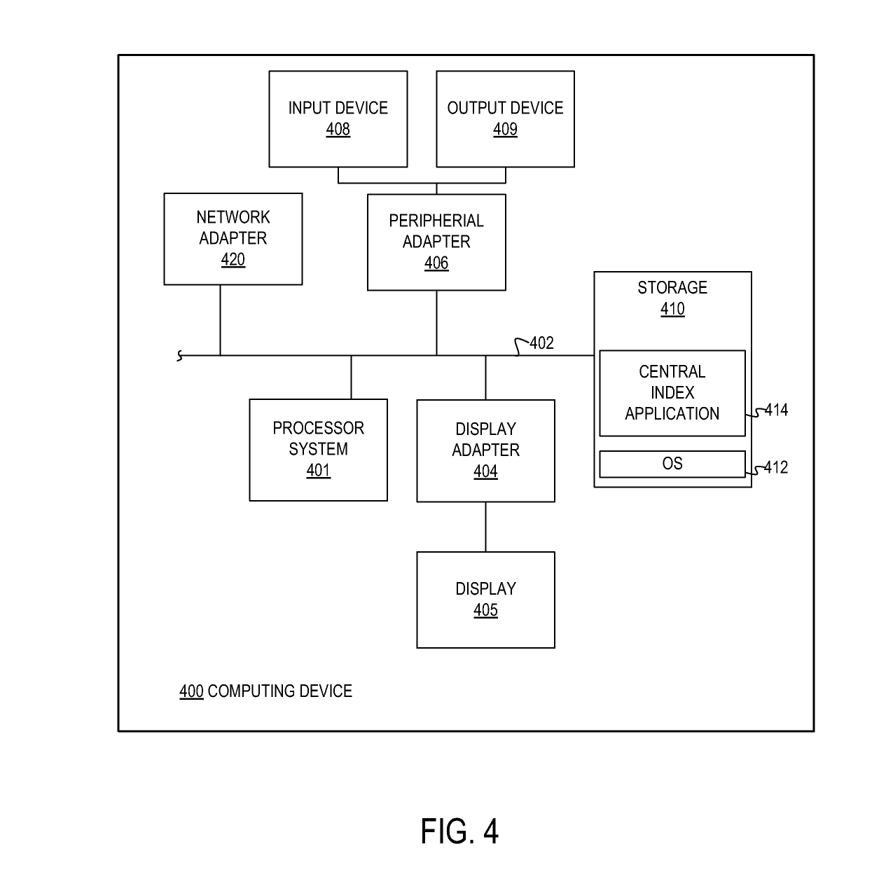

Referring now to FIG. 4, a block diagram illustrating selected elements of an embodiment of a computing device 400 is presented. In various embodiments, computing device 400 may represent an instance of a computer system configured to store and/or access data objects 104, configured to execute an instance of data event management 102, configured to execute an instance of central index 108, and/or configured to execute version retrieval 110 (see FIG. 1).

In the embodiment depicted in FIG. 4, device 400 includes processor 401 coupled via shared bus 402 to storage media collectively identified as storage 410. Device 400, as depicted in FIG. 4, further includes network adapter 420 that interfaces device 400 to a network (not shown in FIG. 4). In embodiments suitable for use with backup and recovery systems, as described herein, device 400, as depicted in FIG. 4, may include peripheral adapter 406, which provides connectivity for the use of input device 408 and output device 409. Input device 408 may represent a device for user input, such as a keyboard or a mouse, or even a video camera. Output device 409 may represent a device for providing signals or indications to a user, such as loudspeakers for generating audio signals.

Device 400 is shown in FIG. 4 including display adapter 404 and further includes a display device or, more simply, a display 405. Display adapter 404 may interface shared bus 402, or another bus, with an output port for one or more displays, such as display 405. Display 405 may be implemented as a liquid crystal display screen, a computer monitor, a television or the like. Display 405 may comply with a display standard for the corresponding type of display. Standards for computer monitors include analog standards such as video graphics array (VGA), extended graphics array (XGA), etc., or digital standards such as digital video interactive (DVI), high definition multimedia interface (HDMI), among others. A television display may comply with standards such as National Television System Committee (NTSC), Phase Alternating Line PAL), or another suitable standard.

Display 405 may include an output device 409, such as one or more integrated speakers to play audio content, or may include an input device 408, such as a microphone or video camera. In some embodiments, device 400 may be configured without (i.e., may exclude) at least one of input device 408, output device 409, and display 405.

Storage 410 encompasses persistent and volatile memory media, fixed and removable memory media, and magnetic and semiconductor memory media. Storage 410 is operable to store instructions, data, or both. Storage 410 as shown includes sets or sequences of instructions, namely, an operating system 412, and central index application 414. Operating system 412 may be a UNIX or UNIX-like operating system, a Windows® family operating system, or another suitable operating system. It is noted that central index application 414 may be executed as a service or as a plug-in to operating system 412.

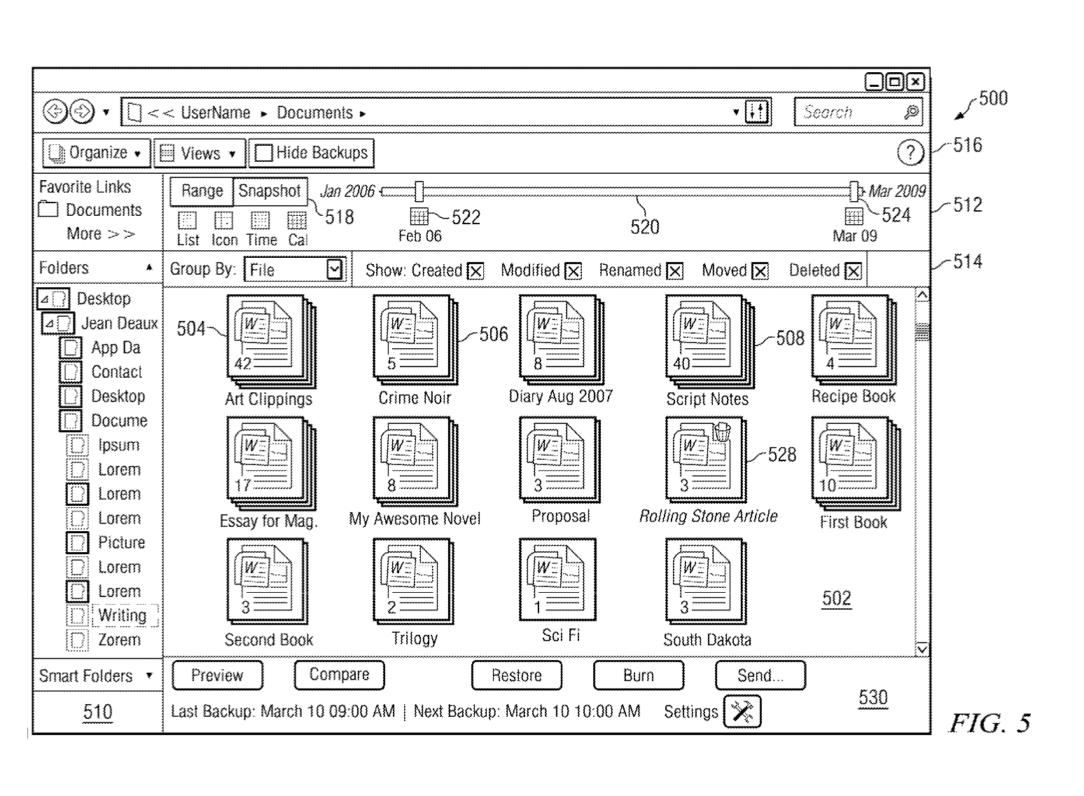

Turning now to FIG. 5, selected elements of embodiments of a user interface are shown in single panel display object 500. Single panel display object 500, as shown, comprises various elements, including data object panel 502, directory tree 510, timeline 512, selection bar 514, browser bar 516, and backup control 530. It is noted that the elements depicted in single panel display object 500 may be rearranged or omitted in various embodiments.

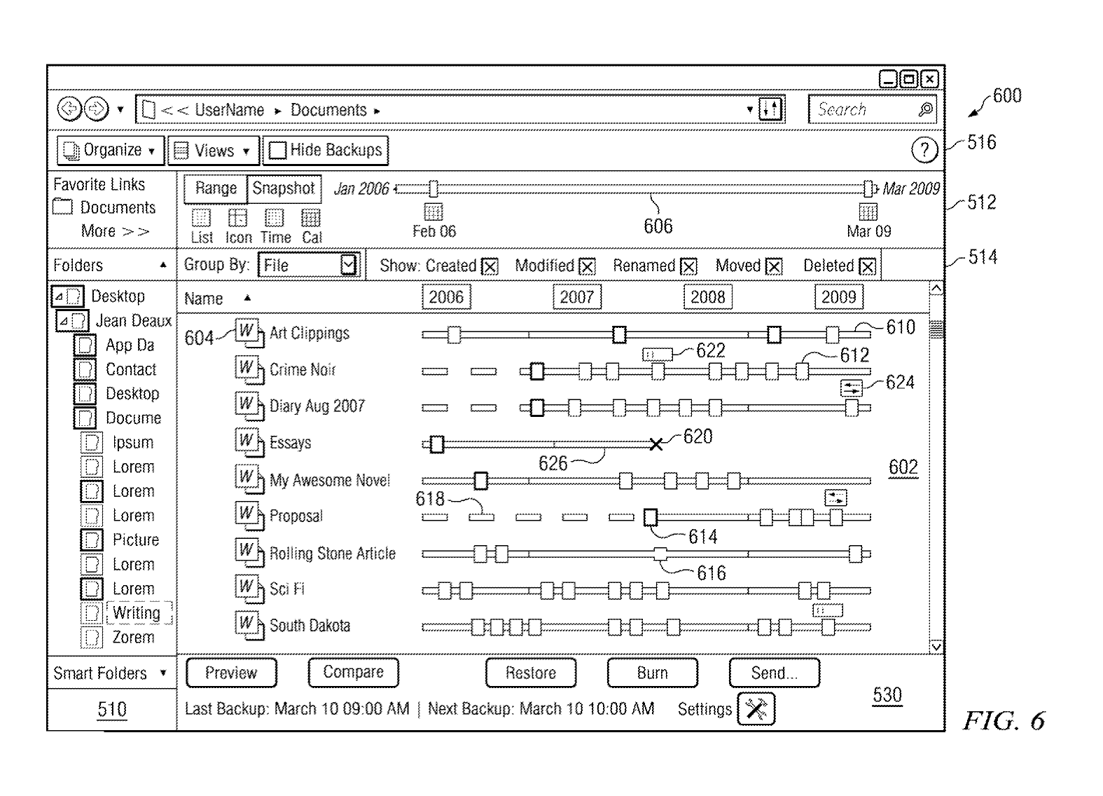

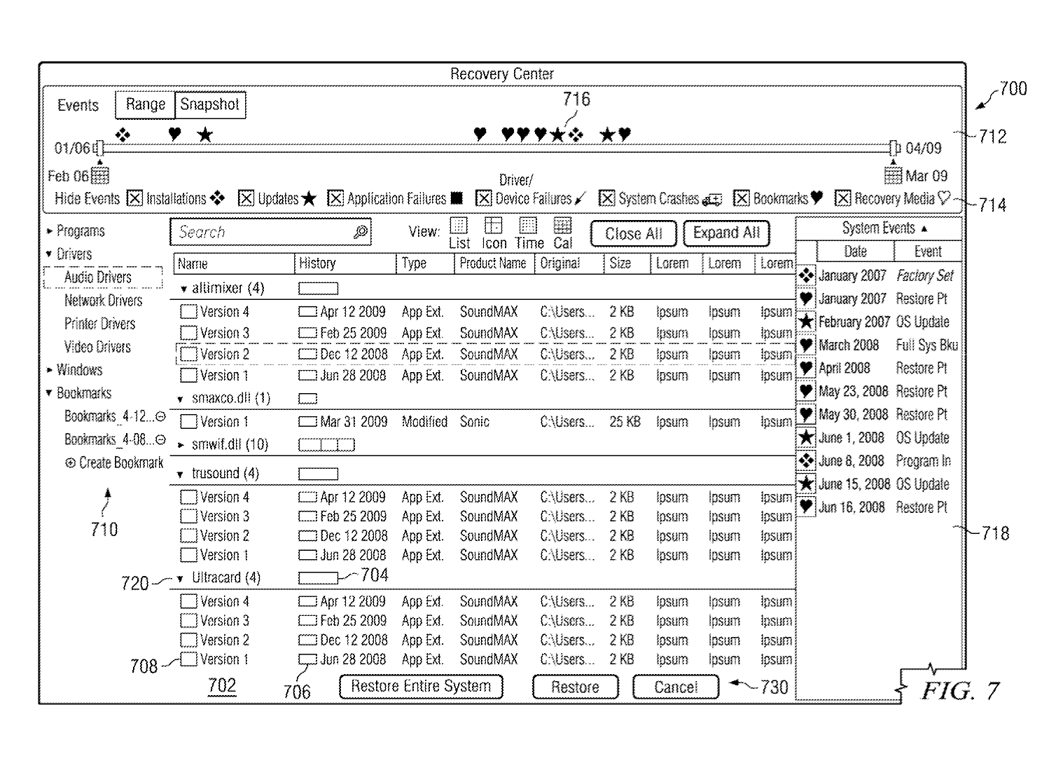

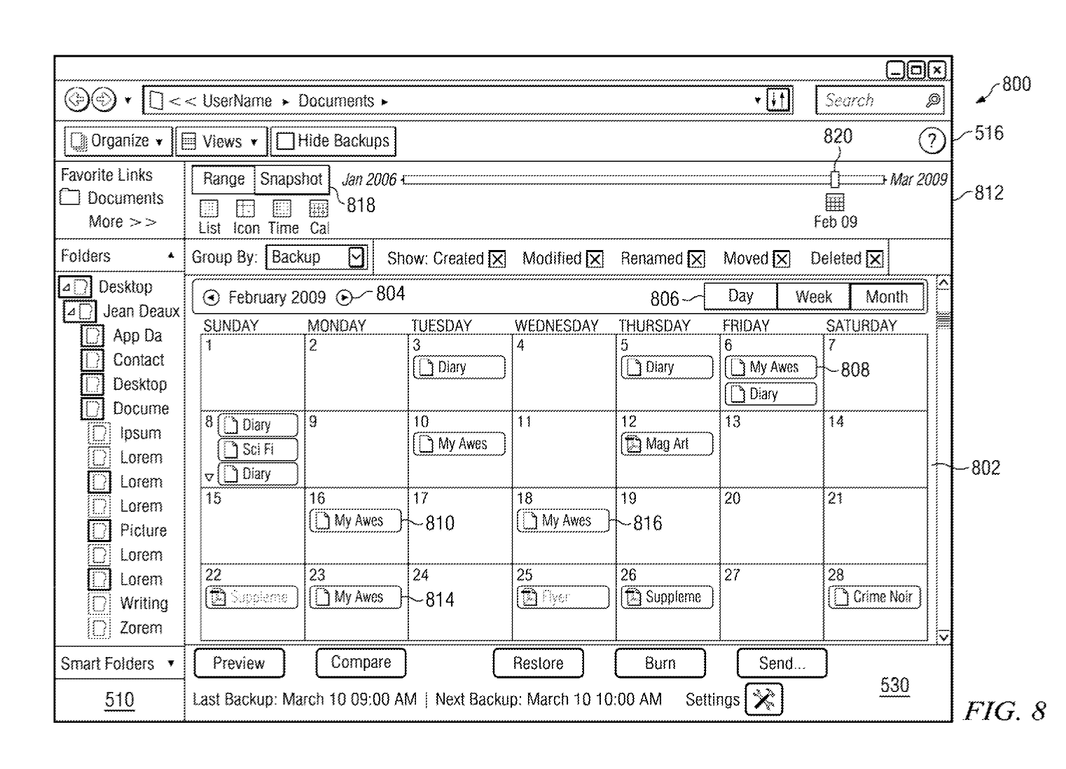

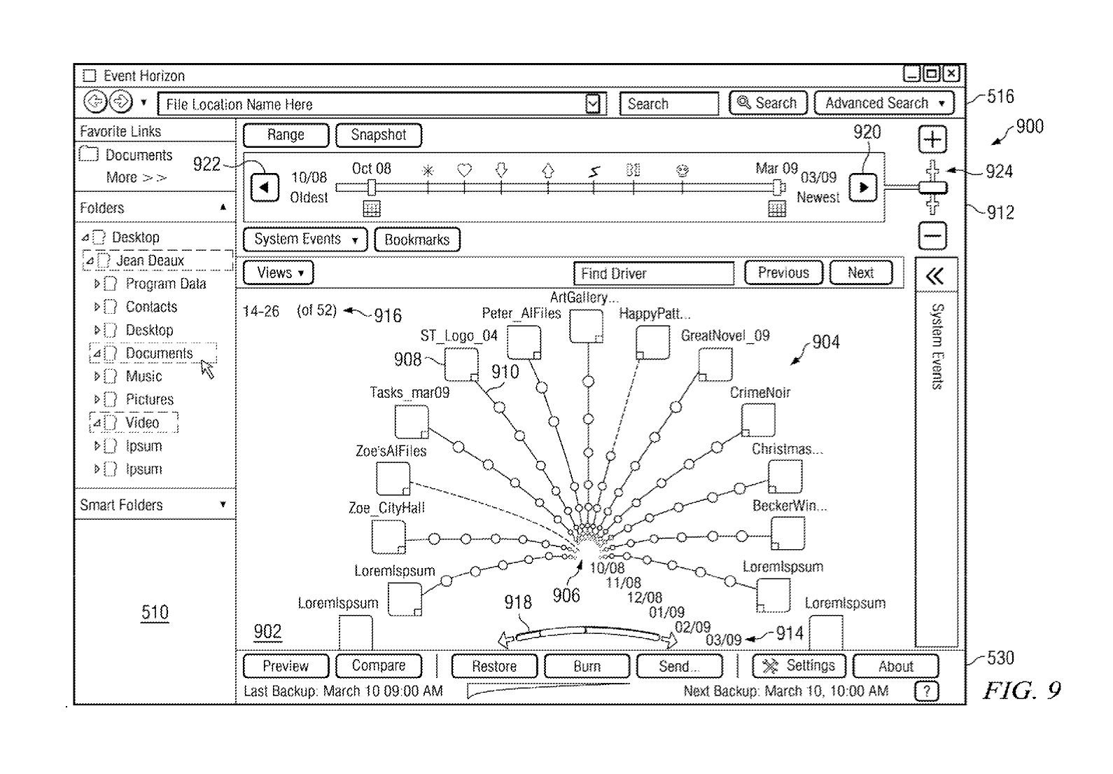

In FIG. 5, data object panel 502 represents a display region where representations of data objects may be displayed. In some embodiments, the representations of data objects displayed in data object panel 502 are generated from metadata stored in central index 108. Data object panel 502 may display data objects in various different “views” including a list view (FIG. 7), an icon view (FIG. 5), a timeline view (FIG. 6), a time tunnel view (FIG. 9), and a calendar view (FIG. 8). In some embodiments, selection of the various views be performed by clicking a view selection icon, four of which are depicted in FIG. 5 located below the Range/Snapshot selection 518. Although a view selection icon corresponding to the time tunnel view depicted in FIG. 9 is not shown, other embodiments may include such an icon or other icons. Data object panel 502 may correspond to a location on a storage device selectable by another element or in another region within single panel display object 500. That is, data objects displayed in data object panel 502 may correspond to a particular storage location associated with a storage device or with a computer system. Accordingly, data objects displayed in data object panel 502 may be shown according to a name, such as a filename, or other attribute. The filename may be used along with a location specifier to generate a unique file path for each data object. When a location or other selection attribute for data objects is selected, the central index may be queried for data objects that satisfy a criteria associated with a data object attribute, which may specify at least one of: size, type, location, creation date, modification date, deletion date, owner, and security information.

Data objects displayed in data object panel 502 may include data objects 504, 506, 508, and 528, among others. As shown in data object panel 502, each data object may be represented by a stack, with a varying number of layers, which are related to the number of backup copies, or previous versions of a stored revision history, corresponding to that particular data object. A data object, along with its revision history, may be stored in the central index. The topmost item, or layer, in a stack may have a number in the lower left corner indicating the number of items in the revision history available for that data object. Accordingly, data object 504, shown having 42 items, may be shown with a greater number of layers than data object 506, shown having 5 items. In certain embodiments, the number of layers displayed in a stack may not directly reflect the actual number of items. In particular, above a certain value, the number of layers may be symbolic in nature or may be bounded. In this manner, data object panel 502 may exhibit certain features of a revision history for a plurality of data objects.

Furthermore, data objects in data object panel 502 may be displayed with color attributes (not shown in FIG. 5). The color attributes may be related to a color scale associated with timeline 512, as will be discussed below. That is, each layer in a stack may be colored according to its relative position in time that the corresponding version of the data object was modified. It is noted that individual layers of a stack may themselves represent selectable and accessible data object versions. In one illustrative example, by selecting a layer that is not topmost and providing user input indicating a command to open data object 504, a previous version of data object 504 associated with the selected layer may be accessed. Accessing a previous version of a data object from a data object revision history may include at least one of: selecting, retrieving, displaying, comparing, sending, opening, executing, forwarding, copying, and emailing. When this previous version is then modified and saved, the layer in the stack may be updated with a color indicating a very recent edit. In this example, the layer colors of the stack of data object 504 may show colors indicating earlier layers on top of colors indicating later layers. Accordingly, in particular embodiments, the stack for data object 504 may have a different coloring than the stack for data object 508. If previous versions of data object 508 have not been modified after subsequent versions have been created, then the time range indicated by the layer colors of the stack of data object 508 may correspond to continually earlier points in time, i.e., a continuous color scale into the past. In this manner, data object panel 502 may exhibit particular features of a revision history for a plurality of data objects.

Also displayable on data object panel 502 are indications of data objects that have been deleted, such as data object 528. Data object 528 is shown with a trash can symbol on the top layer, indicating that data object 528 has been deleted, or marked for deletion. In certain embodiments, operations causing the opening and/or modifying of deleted data objects may not be available. In certain embodiments, data object 528, or metadata associated with data object 528, such as a previous version of data object 528 stored in the central index, may be deleted based on age. It is noted that the central index may include functionality for reducing consumption of overall storage volume by selecting certain versions of stored data objects for automatic deletion. For example, time intervals for previously stored versions of a data object may increase as the age of the data object increases.

In FIG. 5, directory tree 510 represents a series of collapsible displays of locations, or file system directories, associated with a storage object. Directory tree 510 may be used to select a location whose contents may then be displayed in data object panel 502, while the location is displayed in browser bar 516. The location of data objects displayed in data object panel 502 may be given by a URL in browser bar 516. Alternatively, a location may be entered as text in browser bar 516, which may also include additional features for display options.

Also shown in FIG. 5 is timeline 512, which may display a selectable time range or a snapshot in time, selectable by range/snapshot control 518. As shown in FIG. 5, range/snapshot control 518 is set to ‘Range, ’ such that timeline bar 520 is shown with two (2) time controls 522 and 524. When range/snapshot control 518 is set to ‘Snapshot,’ timeline bar 520 may exhibit a single time control (not shown in FIG. 5, see FIG. 8). When ‘Range’ is selected, time controls 522 and 524 may increment by a given time unit. When ‘Snapshot’ is selected a single time control (not shown in FIG. 5) may increment by previous backup events that have been performed on the computing environment.

Timeline bar 520 and time controls 522 and 524 may be colored according to a color scale (not shown in FIG. 5). As discussed previously, the color scale may be a botanic scale. It is noted that the time range may be selected by entering a time value in either of time controls 522 and 524. Time controls 522 and 524 may automatically arrange themselves, such that time control 522 is always earlier than time control 524, regardless of a new time value entered at either time control. When the values for time controls 522 and 524 are changed, the displayed data objects in data object panel 502 may automatically change color to reflect the current color scale settings of timeline 512.

Further included in FIG. 5 is selection bar 514, which may provide options for selecting the type of data objects to display in data object panel 502. Among the options available for selection bar 514 are created, modified, renamed, moved, and deleted. In combination with the selection of the location, using directory tree 510 or browser bar 516, and the selection of data objects with selection bar 514, as well as the values for timeline 512, the resulting displayed indications of data objects in data object panel 502 may be operated on with features provided by backup control 530. Backup control 530 may include functions for performing backups, such as preview and compare and restore, as well as functions for processing a selected set of data objects, such as burn and send.

Turning now to FIG. 6, selected elements of embodiments of a user interface are shown in single panel display object 600. Single panel display object 600, as shown, comprises various elements, including data object panel 602, directory tree 510, timeline 512, selection bar 514, browser bar 516, and backup control 530. It is noted that the elements depicted in single panel display object 600 may be rearranged or omitted in various embodiments. It is further noted that like numbered elements in FIG. 6 represent the same elements discussed above with respect to FIG. 5.

In FIG. 6, data object panel 602 represents another embodiment of data object panel 502 (see FIG. 5) using individual timelines for representing data objects and their respective revision histories, instead of stacks with layers. For example, data object 604 may be associated with its individual timeline bar 610, showing a number and relative times associated with previously backed up copies, or previous versions comprising a revision history, of data object 604. Each individual previous version may be represented by a block, such as block 612. Additional symbols near a block may further indicate additional data events associated with the data object and the time of the data event. For example, a renaming of a data object may be represented by text block 622. A moving of a data object to another location may be represented by arrow block 624. A deletion of a data object may be represented by X mark 620, along with the termination of timeline bar 626. A dashed timeline bar, such as timeline bar 618, may indicate that a corresponding data object has not yet been created. A creation of a data object may be represented by bold block 614. A modification of a data object may be represented by plain block 616. In this manner, data object panel 602 may exhibit particular features of a revision history for a plurality of data objects. Data object panel 602 enables the selection and comparison of different data objects at different points in time. For example, using data object panel 602, a user could select and compare the version of the “Crime Noir” data file represented by block 612 with a version of the “Proposal” document represented by bold block 614 even though these two blocks represent the states of two different data files at two different points in time, i.e., two different time stamps.

Referring now to FIG. 7, selected elements of embodiments of a user interface are shown in single panel display object 700. Single panel display object 700, as shown, comprises various elements, including data object panel 702, directory tree 710, timeline 712, selection bar 714, and restore control 730. It is noted that the elements depicted in single panel display object 700 may be rearranged or omitted in various embodiments. Single panel display object 700 may represent a user interface for recovery and/or restoration of data objects. In certain embodiments, single panel display object 700 may be reached by selecting ‘Restore’ in backup control 530 (see FIG. 5).

In FIG. 7, single panel display object 700 may include directory tree 710 for selecting a location or a grouping of data objects by category, on which the content displayed in data object panel 702 is based. As shown in FIG. 7, ‘Audio Drivers’, under the category drivers in directory tree 710, are currently selected (i.e., expanded) for a corresponding display in data object panel 702.

Also depicted in FIG. 7, single panel display object 700 may include timeline 712 and selection bar 714. Timeline 712 may be substantially similar in operation and display compared to timeline 512 (see FIG. 5). Timeline 712 may further include data event markers 716, which may represent various data events occurring on a computer system within a selected time range. Selection bar 714 may allow the selection of data event markers 716 to display on timeline 712. As shown in FIG. 7, data event markers 716 may include markers for data events such as installations, updates, application failures, driver/device failures, system crashes, bookmarks, and recovery media. As noted previously, a bookmark is a user-defined timestamp marker that may be associated with a snapshot or a range in time. Timeline 712 may display a plurality of data event markers 716 with an indication of when in the displayed time range a data event corresponding to each data event marker 716 occurred. In certain embodiments, single panel display object 700 may further include system events 718, which may display a list of data events corresponding to data event markers 716. As noted previously, when ‘Snapshot’ is selected for timeline 712, a time control associated with timeline 712 may increment according to data event markers 716 that are present. It is noted that data event markers 716 or an entry in system events 718 may be a selectable element, for example, to determine a time range or a time snapshot for displaying data objects.

In single panel display object 700, a data object may be represented by a table entry, such as data object 720. The table entry for data object 720 may include an indication of previous versions of data object 720, such as data object version 708. Data object version 708 may further be associated with a respective color element, shown as color box 706. Color box 706 may represent the relative age of data object 720 given by a color scale (not shown in FIG. 7) for timeline 712. In addition, data object 720 may also include a respective color element display, shown as color box 704. Color box 704 may display a color gradient (not shown in FIG. 7) indicative of a revision history for data object 720, defined by a number of previous data object versions and their respective ages and color boxes according to the selected color scale. It is noted that the color scale may be a botanic color scale. Thus color box 704 may display information indicative of a revision history for data object 720, even when individual data object versions are not explicitly displayed.

Further shown in FIG. 7 is restore control 730, which may be used for restoring or recovering previously stored versions of data objects displayed in data object panel 702. Restore control 730, as shown, may also provide an option for restoration of an entire computer system environment.

Turning now to FIG. 8, selected elements of embodiments of a user interface are shown in single panel display object 800. Single panel display object 800, as shown, comprises various elements, including data object panel 802, directory tree 510, timeline 812, browser bar 516, and backup control 530. It is noted that the elements depicted in single panel display object 800 may be rearranged or omitted in various embodiments. It is further noted that like numbered elements in FIG. 8 represent the same elements discussed above with respect to FIG. 5.

In FIG. 8, data object panel 802 represents another embodiment of data object panel 502 (see FIG. 5) using a calendar view for representing data objects and their respective revision histories, instead of stacks with layers. In data object panel 802, the duration of the calendar view may be selected by day/week/month control 806. Calendar scroll control 804 may permit incremental or decremental change of the calendar view in time units of the duration selected by day/week/month control 806. In certain embodiments, elements of day/week/month control 806 and/or calendar scroll control 804 may be disabled, depending on the timescale selected by timeline 812. Data objects, such as data object 808, may be displayed in the calendar view in data object panel 802 according to their date. Data objects 810, 816 and 814 may represent later versions of data object 808 available for processing in the calendar view.

As shown in FIG. 8, timeline 812 may be substantially similar in operation and display compared to timeline 512 (see FIG. 5). Timeline 812 is shown with a single time control in snapshot mode, such that all displayed data objects in data object panel 802 correspond to the selected time snapshot. In one embodiment, all displayed data objects may be shown with the same color, corresponding to a color scale (not shown in FIG. 8) of timeline 812. In other implementations, timeline 812 may continue to define a color scale, even in snapshot mode, such that displayed data objects are shown at the snapshot time with their respective ages given by the color scale. As in the previous figures, the color scale may be a botanic color scale. It is noted that in FIG. 8, timeline 812 is shown with range/snapshot control 818 set to ‘Snapshot’, such that timeline 812 displays a single instance of time control 820. It is further noted that time control 820 may increment according to previous data events, such as backup events or system events (see FIG. 7) recorded in the central index.

Advancing now to FIG. 9, selected elements of embodiments of a user interface are shown in single panel display object 900. Single panel display object 900, as shown, comprises various elements, including data object panel 902, directory tree 510, timeline 912, browser bar 516, and backup control 530. It is noted that the elements depicted in single panel display object 900 may be rearranged or omitted in various embodiments. It is further noted that like numbered elements in FIG. 9 represent the same elements discussed above with respect to FIG. 5.

In FIG. 9, data object panel 902 represents another embodiment of data object panel 502 (see FIG. 5) using a tunnel view for representing data objects and their respective revision histories. The tunnel view may comprise an outer portion 904, in which a number of data objects may be represented in a circular fashion. As shown in FIG. 9, data object panel 902 can accommodate 13 representations (in this case, icons) of data objects in outer portion 904. Other arrangements, sizes and capacities may be practiced in various embodiments. The tunnel view may also comprise an inner portion 906, in which a timeline for each respectively represented data object may be depicted. For example, data object 908 is associated with tunnel timeline 910, which indicates earlier versions of data object 908 recorded in a central index. Tunnel timeline 910 may further be correlated with tunnel timescale 914 for representing a certain time period. Tunnel timeline 910 may further conform to a color scale (not shown in FIG. 9) defined by timeline 912, such as a botanic time scale.

Also depicted in data object panel 902 are numerical indicator 916 and associated sliding control 918. In operation, data object panel 902 may display data objects stored at a particular location on a computer system, for example given by directory tree 510 and/or browser bar 516. Because the display capacity of data object panel 902 may be limited to a number smaller than the number of data objects at the selected location, an ordinal range of the currently displayed data objects and the total number of data objects at the selected location may be displayed by numerical indicator 916. Sliding control 918 may provide functionality to increment or decrement the displayed ordinal range of data objects in data object panel 902.

In FIG. 9, timeline 912 may represent an embodiment of timeline 512 (see FIG. 5). As shown in the illustrative embodiment of FIG. 9, timeline 912 may include increment buttons 920 and 922 for incrementing the currently displayed range of timeline 912 either forwards or backwards in time, respectively. Timeline 912 may further include zoom control 924 for zooming in or zooming out the time range of timeline 912.

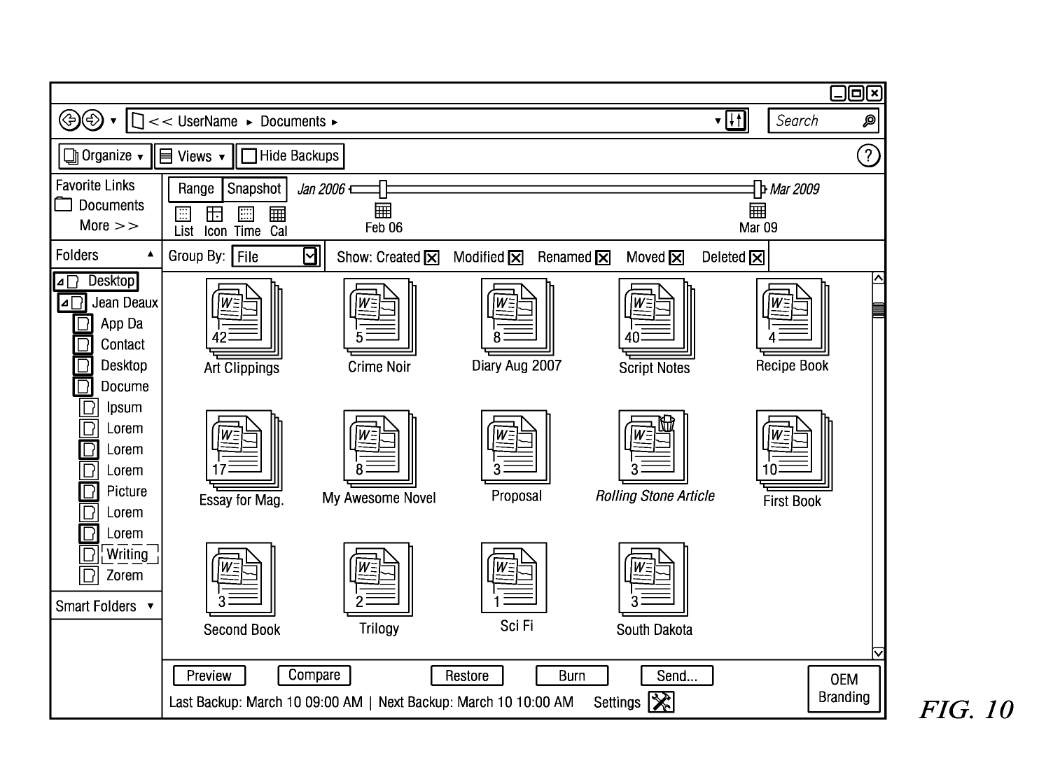

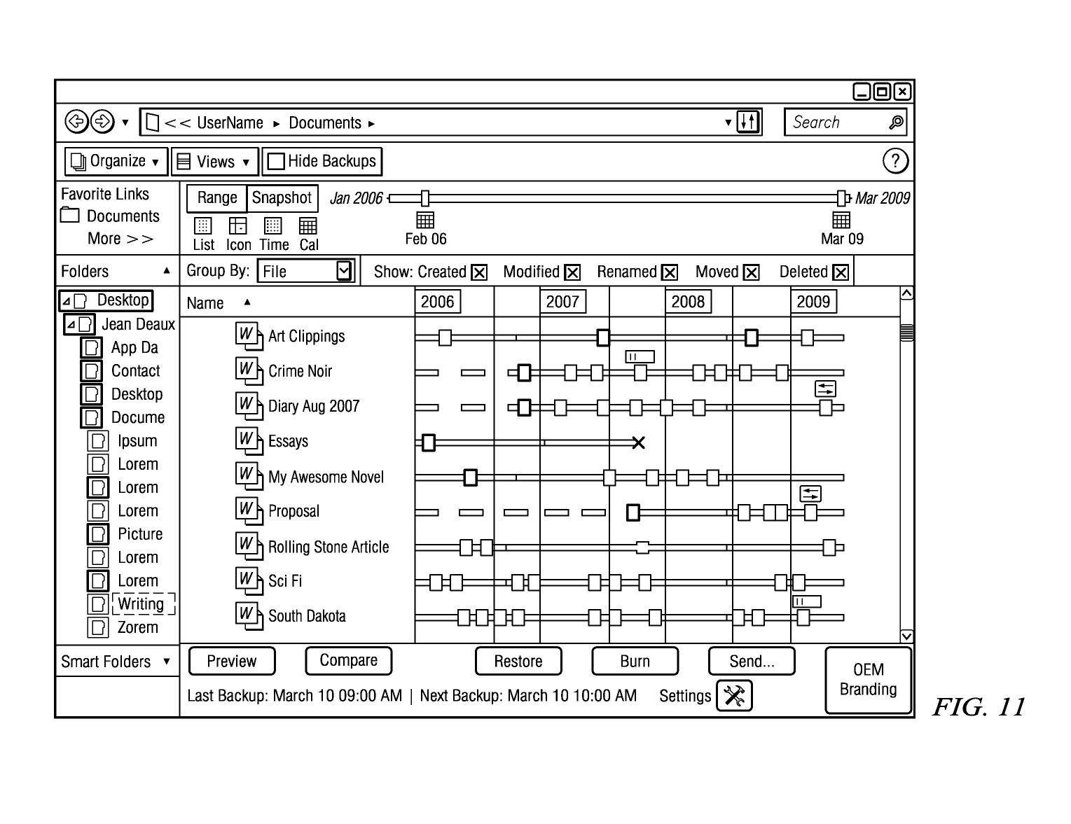

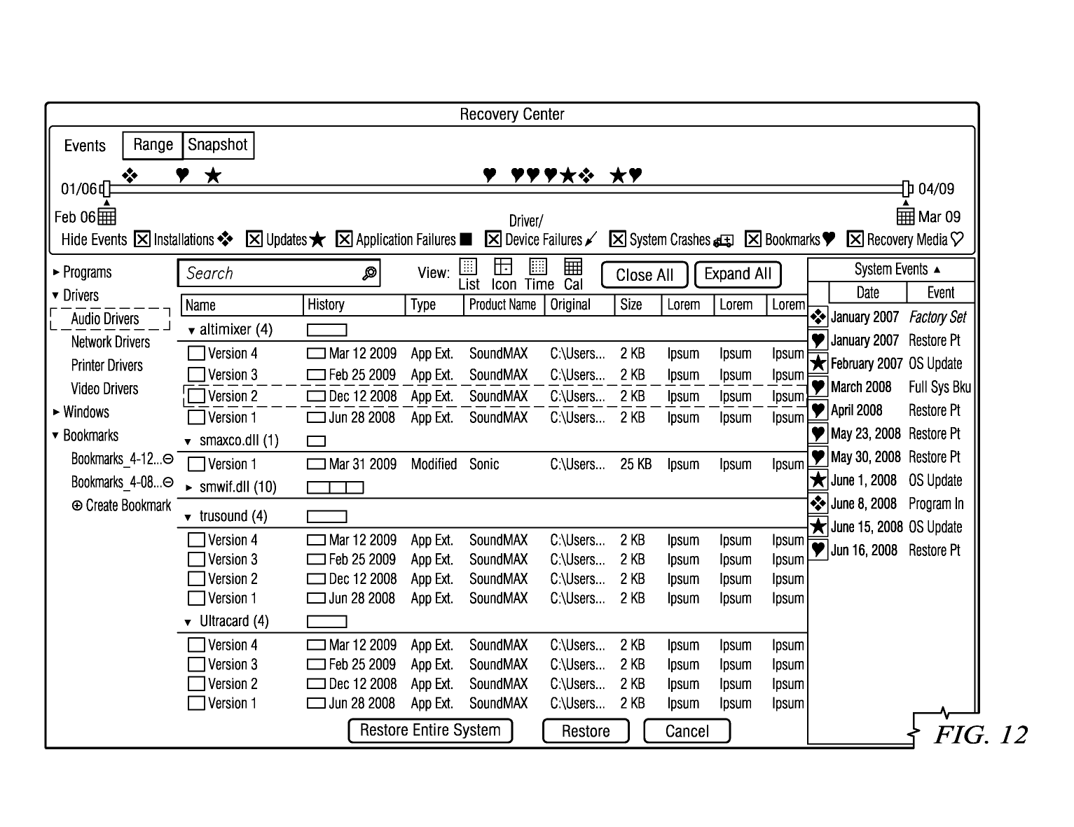

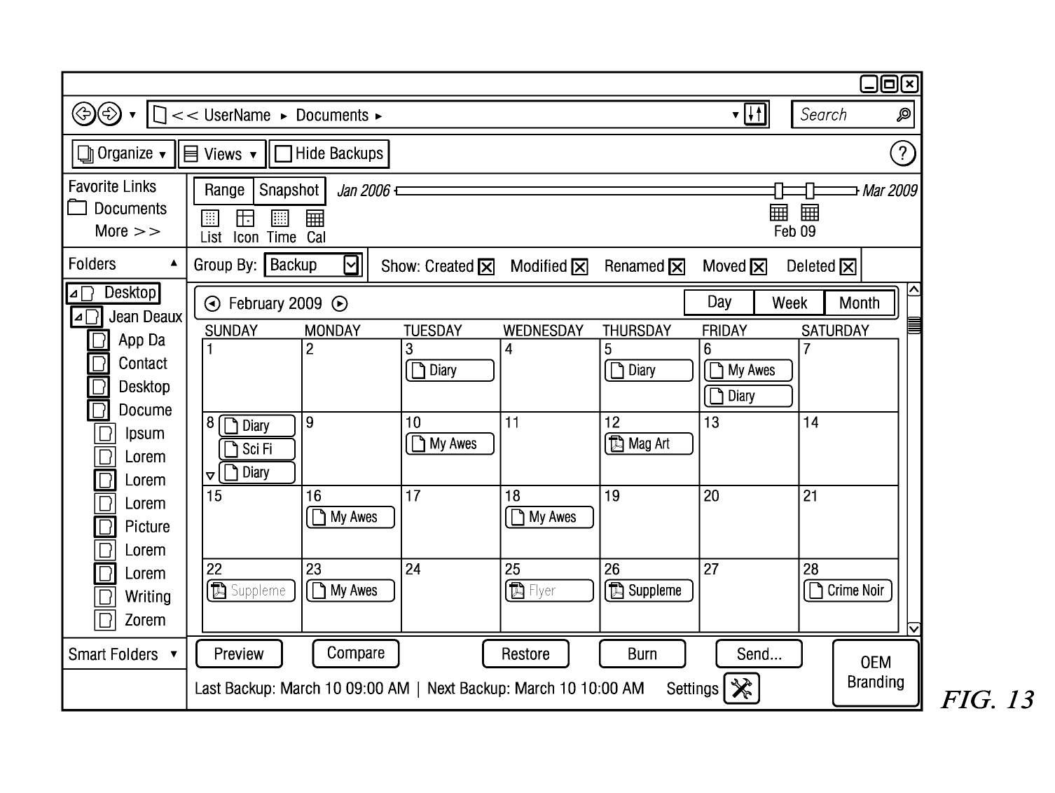

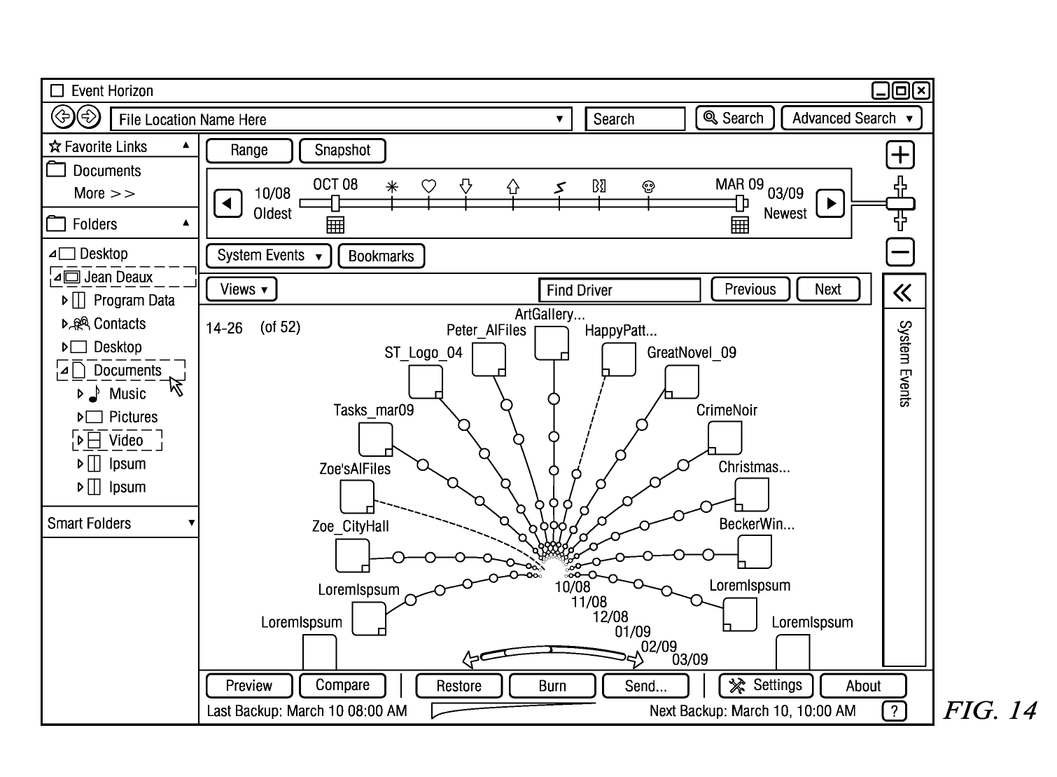

Turning now to FIGS. 10-14, these figures depict additional embodiments of representations of user interfaces comprising single panel display objects, along with the corresponding user interface elements integrated therein, as illustrated in FIGS. 5-9, respectively. FIG. 10 is substantially similar to the embodiment of single panel display object 500 shown in FIG. 5. FIG. 11 is substantially similar to the embodiment of single panel display object 600 shown in FIG. 6. FIG. 12 is substantially similar to the embodiment of single panel display object 700 shown in FIG. 7. FIG. 13 is substantially similar to the embodiment of single panel display object 800 shown in FIG. 8. FIG. 14 is substantially similar to the embodiment of single panel display object 900 shown in FIG. 9.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for maintaining a central index of a computing environment, comprising:
identifying data events respectively associated with data objects stored in the computing environment, wherein the data objects include user files and system files;
storing metadata indicative of an identified data event, including a timestamp, in the central index; and
when the identified data event represents revision of a respective data object, storing metadata associated with the revised data object in the central index.

2. The method of claim 1, further comprising:
when the identified data event represents creation of a respective data object, storing metadata associated with a created data object in the central index; and
when the identified data event represents deletion of a respective data object, storing metadata associated with a deleted data object in the central index.

3. The method of claim 1, wherein the data objects further include at least one executable program file, and wherein the data events include: installation, setup, modification, renaming, moving, error reporting, deletion, and permanent deletion.

4. The method of claim 1, wherein the system files include at least one hardware driver file for accessing a hardware component of the computing environment.

5. The method of claim 4, wherein a data event associated with a hardware driver file indicates at least one of: configuration of the hardware component, an error of the hardware component, failure of the hardware component, removal of the hardware component from the computing environment, and detection of the hardware component being added to the computing environment.

6. The method of claim 1, further comprising:
displaying a selectable representation of a plurality of the data objects in a single panel display object, wherein the representation includes data object revision histories retrieved from the central index.

7. The method of claim 6, wherein the represented data objects include coloring according to a color scale, wherein the color scale represents a time scale of a data object revision history.

8. The method of claim 7, wherein the color scale is a botanic color scale.

9. The method of claim 7, further comprising:
representing the time scale and the color scale with a timeline for the plurality of data objects; and
enabling a user to provide user input to the timeline for selecting the time scale.

10. The method of claim 6, wherein the representation of the data object revision history includes a respective timeline for data objects within the single panel display object.

11. The method of claim 10, wherein the timeline represents a non-linear timescale for time units ranging from hours to at least one of: days, weeks, and months.

12. The method of claim 10, wherein more recent portions of the respective timelines appear closer than less recent portions of the timelines.

13. The method of claim 10, wherein the timeline includes a means for selecting between a time range with dual time selectors and a time snapshot with a single time selector.

14. The method of claim 13, wherein when the time range is selected, the dual time selectors increment by a given time unit, and wherein when the time snapshot is selected, the single time selector increments by previous backup events that have been performed on the computing environment.

15. The method of claim 6, wherein the data object revision histories are represented as stacks associated with the represented data objects, wherein the size of the stacks correlates with a number of data events occurring within a selected time range.

16. The method of claim 15, wherein the topmost item in the stack indicates the number of data events represented in the stack.

17. The method of claim 15, wherein the items in the stack are colored according to a color scale that represents a time scale.

18. The method of claim 15, wherein the topmost item in the stack of a deleted data object includes a deletion graphic element, the topmost item in the stack of a moved data object includes a moved graphic element, and the topmost item in the stack of a renamed data object includes a renamed graphic element.

19. The method of claim 6, further comprising:
enabling a user to access a previous version of a data object from a data object revision history, wherein said access includes at least one of: selecting, retrieving, comparing, displaying, sending, opening, executing, forwarding, copying, and emailing.

20. The method of claim 1, further comprising:
querying the central index for data objects that satisfy a criteria associated with a data object attribute, wherein the data object attribute specifies at least one of: size, type, location, creation date, modification date, deletion date, owner, and security information.

21. The method of claim 20, further comprising:
deleting the data objects returned by said querying.

22. The method of claim 1, further comprising:
storing a bookmark in the central index, wherein the bookmark includes a user-specified timestamp associated with the computing environment.

23. The method of claim 22, further comprising:
querying the central index for versions of data objects associated with a bookmark; and
displaying the data objects returned by said querying.

24. The method of claim 23, wherein the versions of data objects associated with a bookmark are previously stored copies of the data objects at the time of the bookmark timestamp.

25. The method of claim 1, further comprising:
responsive to user input, enabling the user to delete previous versions of data objects stored in the central index.

26. A computer system comprising:
a processor;
a storage device configured for storing data objects;
a display device for displaying a user interface; and
memory media accessible to the processor, including processor executable instructions to:
identify data events respectively associated with data objects stored on the storage device, wherein the data objects include user files and system files;
store an indication of an identified data event, including a timestamp, in the central index; and
represent a plurality of data objects in a single panel display object of the user interface, including processor executable instructions to represent revision histories for the respective represented data objects, wherein the revision history is retrieved from the central index.

27. The computer system of claim 26, further comprising processor executable instructions to:
when the identified data event represents creation of a respective data object, store metadata associated with a created data object in the central index;
when the identified data event represents revision of a respective data object, store metadata associated with a revised data object in the central index; and
when the identified data event represents deletion of a respective data object, store metadata associated with a deleted data object in the central index.

28. The computer system of claim 27, wherein the revision histories include information indicative of previous versions for the respective data object.

29. The computer system of claim 27, further comprising processor executable instructions to:
responsive to user input, retrieve a previous version of a data object from the central index; and
display the previous version of the data object on the display device.

30. The computer system of claim 26, wherein the represented data objects include coloring according to a color scale, wherein the color scale represents a time scale of a data object revision history.

31. The computer system of claim 30, wherein the displayed color scale is a botanic color scale.

32. The computer system of claim 26, wherein the data events include: installation, setup, modification, error reporting, and deletion.

33. Computer-readable memory media, including executable instructions for maintaining a central index of a computing environment, said instructions executable to:
identify data events respectively associated with data objects stored in the computing environment, wherein the data objects include user files and system files;
store an indication of an identified data event, including a timestamp and a location of an associated data object, in the central index;
when the identified data event indicates creation of a respective data object, store metadata associated with a created data object in the central index;
when the identified data event indicates revision of a respective data object, store metadata associated with a revised data object in the central index; and
when the identified data event indicates deletion of a respective data object, store metadata associated with a deleted data object in the central index.

34. The memory media of claim 33, further comprising instructions executable to:
display indications of a plurality of data objects in a single panel display object, including executable instructions to display an indication of revision histories for respective data objects, wherein the revision histories are retrieved from the central index.

35. The memory media of claim 33, wherein the data objects are stored on a plurality of storage devices accessible to the computing environment.

36. The memory media of claim 35, wherein the storage devices include at least one of: optical storage devices, internal storage devices, external storage devices, storage-area networks, networked storage devices, bus-interfaced storage devices, and solid-state storage devices.

37. The memory media of claim 33, wherein a location of at least one data object is given by a universal resource locator.

38. The memory media of claim 33, further comprising instructions executable to:
delete copies of a data object stored in the central index.

39. The memory media of claim 38, wherein the deleted copies are selected based on age.
